(19) United States
(12) Patent Application Publication
(10) Pub. No.: US 2007/0026272 A1
(43) Pub. Date: Feb. 1, 2007

(54) Fuel cell system

(75) Inventors: Ke Liu, Rancho Santa Margarita, CA (US); Ji-Cheng Zhao, Latham, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/292,583

(22) Filed: Dec. 2, 2005

Related U.S. Application Data
(63) Continuation-in-part of application No. 11/193,970, filed on Jul. 29, 2005.

(51) Int. Cl. H01M 8/06

(52) U.S. Cl. 429/20; 429/17

(57) ABSTRACT

A fuel cell system comprises a hydrogen storage system for storing and releasing hydrogen, a fuel cell in fluid communication with the hydrogen storage system for receiving released hydrogen from the hydrogen storage system and for electrochemically reacting the hydrogen with an oxidant to produce electricity and an anode exhaust. A catalytic combustor is in fluid communication with the fuel cell for receiving the anode exhaust and for catalytically reacting the anode exhaust to produce an offgas having an elevated temperature that is greater than the temperature of the anode exhaust. The heat from the offgas is used to release the hydrogen from the hydrogen storage system.

### CROSS REFERENCE TO RELATED APPLICATIONS

This application is a continuation-in-part of U.S. patent application Ser. No. 11/193,970, entitled “A Fuel Cell System,” filed on Jul. 29^{th}, 2005, and is related to co-pending U.S. patent application Ser. No. ______, having docket number 183593-3 and entitled “Fuel Cell System,” filed concurrently herewith, each of which are herein incorporated by reference.

### BACKGROUND

The invention relates generally to fuel cell systems and more specifically to catalytically combusting an anode exhaust of a fuel cell, for example a Proton Exchange Membrane (PEM) fuel cell, to provide the heat to release hydrogen from a storage material.

Fuel cells, for example PEM fuel cells, are touted as the future of the automotive industry. Fuel cells electrochemically react a fuel, such as hydrogen, with an oxidant, such as air, to produce electricity and water. PEM fuel cells are ideally suited for use in automobiles or for in-home applications and for many other applications.

In order for fuel cells to become practical for use within automobiles, a storage solution must be demonstrated that will provide the necessary quantities of hydrogen to the fuel cell. One of the most common fuel cell and storage combinations is a PEM fuel cell with a metal hydride storage tank. In this system, the metal hydride storage tank is heated and stored hydrogen is released to the PEM fuel cell for electricity generation. A metal hydride must reach a certain temperature before it can release hydrogen. A metal hydride storage system has good volumetric storage density when compared to liquefied and compressed hydrogen systems. Good volumetric storage density is especially important for on-board vehicular storage because it enables adequate hydrogen storage without taking up valuable space on the vehicle.

Several metal hydrides are available commercially, representing a good solution for hydrogen storage where weight and volume are not a significant problem, for example on buses. For most vehicles, however, the problem with metal hydride storage is the high weight of the material compared to the amount of hydrogen that is stored. The problem of weight has still not been solved in spite of extensive research. Researchers are therefore trying to think in new directions, by trying to lighten the alloys or by improving the methods of packing the hydrogen in higher concentrations.

Work is being done to find cheaper metal alloys that have the ability to absorb large amounts of hydrogen and at the same time release the hydrogen at a relatively low temperature. The International Energy Agency's (IEA) metal hydride program has a goal of developing a material that has a reversible storage capacity of 5 weight percent absorbed hydrogen and hydrogen release at less than 100° C., within the next few years. The Department of Energy (DOE) has a goal of developing a material that has reversible storage capacity of 9 weight percent absorbed hydrogen and hydrogen release at less than 100° C. by 2015, still considered to be an extremely aggressive target. Today's modem PEM fuel cells operate at relatively low temperatures, typically at about 80° C. Typically, the excess heat from the fuel cell is used to release the hydrogen from the metal hydride storage tank. Accordingly, it is widely assumed that the most practical applications would require the metal hydride storage tank to release hydrogen at about the same temperature that the fuel cell operates at, for example with PEM fuel cells, this temperature range would be from about 60° C. to about 80° C. It is widely believed that the energy efficiency of the system will be lower, and the system will be more complex, if extra heat must be independently generated to release the hydrogen from the tank.

Accordingly, there is a need to develop an improved fuel cell system that enables utilization of metal hydride storage tanks with higher hydrogen storage capacities without requiring independent heat generation to release the hydrogen from the metal hydride storage tanks.

### BRIEF DESCRIPTION

A fuel cell system comprises a hydrogen storage system for storing and releasing hydrogen, a fuel cell in fluid communication with the hydrogen storage system for receiving released hydrogen from the hydrogen storage system and for electrochemically reacting the hydrogen with an oxidant to produce electricity and an anode exhaust. A catalytic combustor is in fluid communication with the fuel cell for receiving the anode exhaust and for catalytically reacting the anode exhaust to produce an offgas having an elevated temperature that is greater than the temperature of the anode exhaust. The heat from the offgas is used to release the hydrogen from the hydrogen storage system.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of a conventional fuel cell system.

FIG. 2 is a schematic illustration of one embodiment of the instant invention.

FIG. 3 is a schematic illustration of another embodiment of the instant invention.

FIG. 4 is a schematic illustration of yet another embodiment of the instant invention.

FIG. 5 is a schematic illustration of yet another embodiment of the instant invention.

FIG. 6 depicts the results of an ASPEN simulation of a PEM fuel cell with a catalytic combustor and a hydrogen storage system in accordance with one embodiment of the instant invention.

FIG. 7 is a schematic illustration of an experimental unit used for testing one embodiment of the instant invention.

FIG. 8 illustrates test results for a variety of hydrogen concentrations and Gas-Hour-Space-Velocities (GHSV).

FIG. 9 is a schematic illustration of yet another embodiment of the instant invention.

FIG. 10 illustrates test results at an inlet temperature of about 150° C.

### DETAILED DESCRIPTION

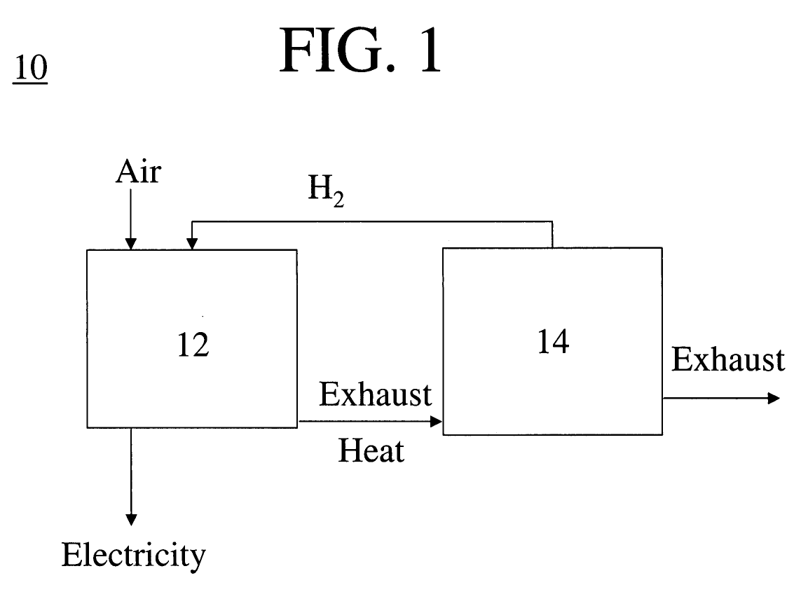

A conventional fuel cell system 10 comprising a fuel cell 12 and a metal hydride storage tank 14 is shown in FIG. 1. Typically, fuel cell 12 is a PEM fuel cell. As shown hydrogen (H₂) and air electrochemically react within fuel cell 12 to produce an exhaust. The exhaust is typically used to heat the metal hydride storage tank 14 to release the hydrogen for electrochemical reaction in the PEM fuel cell 12. The exhaust typically consists of water in the form of steam or moisture, nitrogen, and small quantities of hydrogen. After heating the hydrogen storage tank, the remaining exhausts vents outside of the system. Fuel cell system 10 is suited for many applications, especially for powering an automobile or other vehicles.

As discussed above, a significant challenge associated with implementing fuel cell system 10 into an automobile is the weight of the metal hydride storage tank required to provide sufficient hydrogen to the fuel cell to enable adequate travel distances, for example greater than about 250 miles. Accordingly, a significant amount of research is currently being conducted around identifying reversible metal hydride materials that have a much higher hydrogen storage capacity. One additional difficulty in dealing with these systems is the operating temperatures of the fuel cells. PEM fuel cells operate at about 80° C. There are two factors that limit PEM fuel cells from operating at higher temperatures: 1) the current PEM devices cannot withstand higher operating temperatures without system degradation; and 2) the PEM fuel cells need to be kept at a temperature below the boiling point of water to ensure the system is adequately hydrated. Accordingly, the current operating temperature limit of an ambient pressure PEM system is about 80° C. There are certain advantages to operate at higher temperatures, and for this reason, there are many efforts to develop higher temperature PEM systems. Future advancements of the PEM fuel cell might permit operating temperatures to push upwards to about 150° C.

In order to meet these dueling concerns, researchers have focused on developing high capacity storage materials that release hydrogen at a relatively low temperature, for example less than 100° C. Even if the operating temperature of PEM fuel cells rises to 150° C., it is still not high enough to release most of the hydrogen stored in high-capacity hydrides. For example, the best metal hydride storage solution that releases hydrogen at temperatures less than about 150° C. is currently NaAlH₄ with about 3.5 weight percent released at about 140° C. High capacity reversible metal hydride storage solutions for release at low temperatures are many years away. In fact, DOE has a goal of about 9% reversible storage capacity system, targeted at a release temperature of less than 100° C. in the year 2015. If either the weight limitations or the temperature restrictions were lifted, the implementation of these devices would surely accelerate.

Current metal hydride storage solutions exist that have a reversible storage capacity of greater than 7.5 wt. %, for example, 2LiBH₄+MgH₂, with a current capacity of about 10 wt % of H₂. The release temperature for this material, about 400° C., however, is significantly higher than the operating temperature of PEM fuel cells. For this reason, most of these higher capacity materials have not been researched for use in PEM operated vehicles or other fuel cell applications.

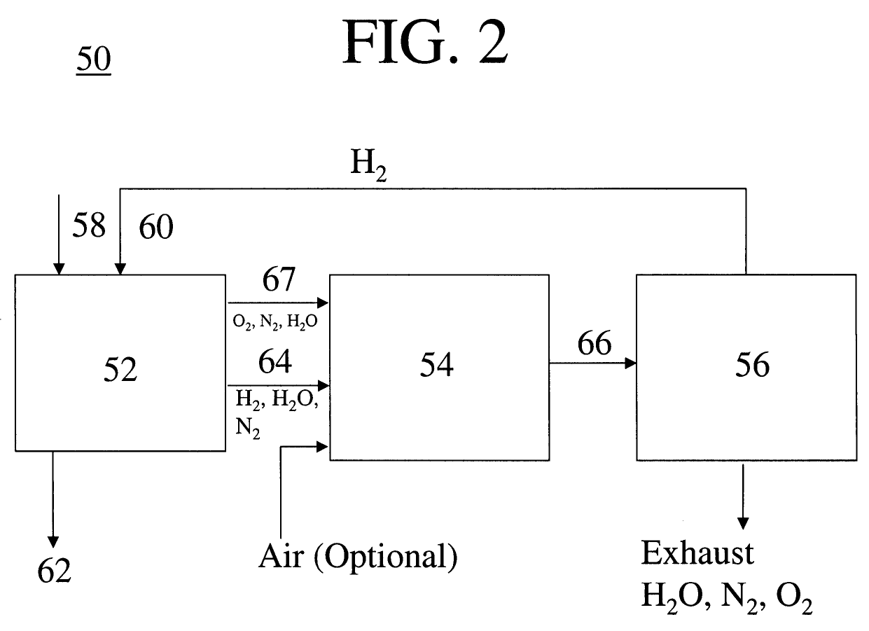

In accordance with one embodiment of the instant invention, a fuel cell system 50 is shown in FIG. 2. Fuel cell system 50 comprises a fuel cell 52, a catalytic combustor 54 and a hydrogen storage system 56. As will be discussed in greater detail below, fuel cell system 50 significantly advances the art of fuel cell systems using hydrogen storage tanks, especially metal hydride storage tanks. The anode exhaust from the fuel cell 52 is combusted in catalytic combustor 54 to produce an offgas with a temperature greater than about 150° C., and typically greater than 300° C. The higher temperature offgas is used to release the hydrogen from hydrogen storage system 56. The higher temperature offgas enables the use of a variety of metal hydride materials, some existing, some yet to be developed, having a reversible storage capacity greater than, for example, 7.5 wt % H₂.

In one embodiment, fuel cell 52 is a PEM fuel cell but can include a variety of other fuel cell types including but not limited to a phosphoric acid fuel cell, a solid oxide fuel cell or an alkali fuel cell. PEM fuel cells are typically associated with onboard or automotive applications, so many discussions within this application will focus on PEM fuel cells. While certain embodiments of this invention may primarily be discussed with reference to PEM fuel cells, this is not a limitation of this invention. An oxidant 58, typically air, and a fuel 60, typically hydrogen (H₂), are introduced into fuel cell 52 and electrochemically react to produce electricity 62 and an anode exhaust 64 comprising water (H₂O), Nitrogen (N₂), Oxygen (O₂) and small quantities of unutilized H₂, for example less than about 15% by volume of the anode exhaust 64, and often less than about 10% by volume, and occasionally between about 2% to about 6% by volume. Typical H₂ utilization efficiency in a PEM fuel cell is less than about 90%, so there is always some percentage of H₂ that cannot be converted inside the PEM fuel cell that is released via the anode exhaust 64. Anode exhaust 64 is typically so dilute in H₂, and contains such large quantities of steam, that homogeneous combustion cannot efficiently be utilized to recover heat from the anode exhaust 64 to take advantage of this otherwise wasted energy. Instead, the anode exhaust 64 is typically used directly, at its existing temperature, around 80° C., to heat the hydrogen storage system to release the hydrogen.

In the instant invention, however, anode exhaust 64 is directed into catalytic combustor 54. The anode exhaust 64 is catalytically reacted to produce an offgas 66 having an elevated temperature, for example greater than about 150° C. and often greater than 300° C. In some embodiments of the invention, the temperature of the offgas 66 is between about 300° C. to about 900° C. In other embodiments of the invention, the temperature of the offgas 66 is between about 300° C. to about 600° C. In one embodiment, a cathode exhaust 67 is directed into catalytic combustor 54. Cathode exhaust 67 contains residual oxygen, for example between about 5% to about 15% by volume of O₂. By using cathode exhaust 67 within catalytic combustor 54 instead of air the system 50 gains efficiency due to the fact that the cathode exhaust 67 is already heated to about 80° C. Additionally, there is typically some amount of steam within the cathode exhaust 67. This is also beneficial to the overall system because steam has greater heat capacity, is a better heat carrier then air, and the latent heat of the steam can be partially recovered by using the catalytic combustor 54 offgas 66 not only to release the H₂ from the storage tank but also to preheat the air as it is provided to fuel cell 52 after the exhaust exits from the hydrogen storage system 56.

In catalytic combustor 54, at least one of the air and the cathode exhaust 67 is mixed with the anode exhaust 64 at a predetermined ratio and is fed to a combustion catalyst such as Pt/Al₂O₃, Pt—Pd/Al₂O₃, Pt—Rh/Al₂O₃, Pt—Ru/Al₂O₃, Pt—Re/Al₂O₃; or Pt—Ir/Al₂O₃, for example. Once the constituents begin to catalytically react, the small amount of H₂ concentration of the anode exhaust 64, will react with O₂ in the air to generate heat. Depending on the H₂ concentration of the anode exhaust 64, and the ratio of air to H₂ feeding into the catalytic combustor 54, the temperature of the catalyst (typically a catalyst bed), and correspondingly the temperature of the offgas 66, can be controlled over a wide temperature range, for example from about 150° C. to about 700° C., and in some cases up to about 900° C.

Hydrogen storage system 56 is typically a metal hydride storage system. While certain embodiments of this invention will discuss hydrogen storage system 56 as a metal hydride storage tank, this is not a limitation of this invention. In fact any hydrogen storage system that requires temperatures greater than about 80° C. to release stored hydrogen to fuel cell system 50 is contemplated within this invention. For example, hydrogen storage systems 56 that employ glass spheres, glass tubes or other hydrogen storage materials are contemplated. Hydrogen storage system 56 is in heat transfer relationship with offgas 66 such that the heat from the offgas 66 can be used to release stored hydrogen within hydrogen storage system 56. As discussed above, because the temperature of offgas 66 is substantially higher than the temperature of the anode exhaust 64 exiting fuel cell 52, metal hydride materials, some existing, some yet to be developed, having a storage capacity greater than, for example, 7.5 wt % H₂ can be used within hydrogen storage system 56. The metal hydride can be either a reversible hydride or a non-reversible hydride. An example of a reversible metal hydride is MgH₂ that has a reversible hydrogen storage capacity of 7.6 wt. %. MgH₂ requires about 300° C. temperature to absorb and release hydrogen. Such a hydride cannot be used in conventional fuel cell system 10, but can be used in the fuel cell systems of the instant invention. Another example of a reversible metal hydride storage material is a mixture of LiBH4 and MgH₂ in a two to one ratio. The material has a demonstrated reversible hydrogen storage capacity of about 10 wt. %, but requires about 400° C. to absorb and release the hydrogen. Again, such a hydrogen storage material cannot be used in conventional fuel cell system 10, but can be used in the fuel cell system 50 of the current invention. One benefit of the increased temperature is that it allows new storage materials with higher absorption and adsorption temperatures to be considered for on-board storage solutions. One additional significant advantage of the increased temperature is faster kinetics that enables fast re-charge of H₂. Ideally one would like to re-charge the H₂ in less than 5 minutes, preferably less than 3 minutes.

Many non-reversible high-capacity hydrides also require higher temperatures to release H₂. An example is LiBH₄ that can decompose to LiH and B and release about 13.8 wt. % H₂. The decomposition temperature is about 280° C. that is not feasible for conventional fuel cell system 10, but can be used in the fuel cell system 50 of the current invention. Another example is NaBH4 that decomposes to NaH and B and releases about 7.9 wt. % H2. The decomposition temperature is about 280° C. that is not feasible for conventional fuel cell system 10, but can be used in the fuel cell system 50 of the current invention. Yet another example of non-reversible hydride is AlH3 that can decomposes to Al and release about 10.1 wt. % H2. The decomposition temperature is about 160° C. that is not feasible for conventional fuel cell system 10, but can be used in the fuel cell system 50 of the current invention. Yet another example is Mg(BH4)2 that can decompose to Mg and B and release about 14.8 wt. % of H2. The decomposition temperature is about 270° C. to about 400° C. that is not feasible for conventional fuel cell system 10, but can be used in the fuel cell system 50 of the current invention.

In addition to the above-mentioned benefits of the instant invention, fuel cell system 50 provides the following additional advantages: the higher temperature offgas 66 can also be used to vary the pressure of the metal hydride storage tank making it unnecessary to use a blower to provide the released H₂ to the fuel cell 52; and an overall reduction in H₂ released to the atmosphere as the catalytic combustor 54 will reclaim most of the H₂ content of the anode exhaust 64.

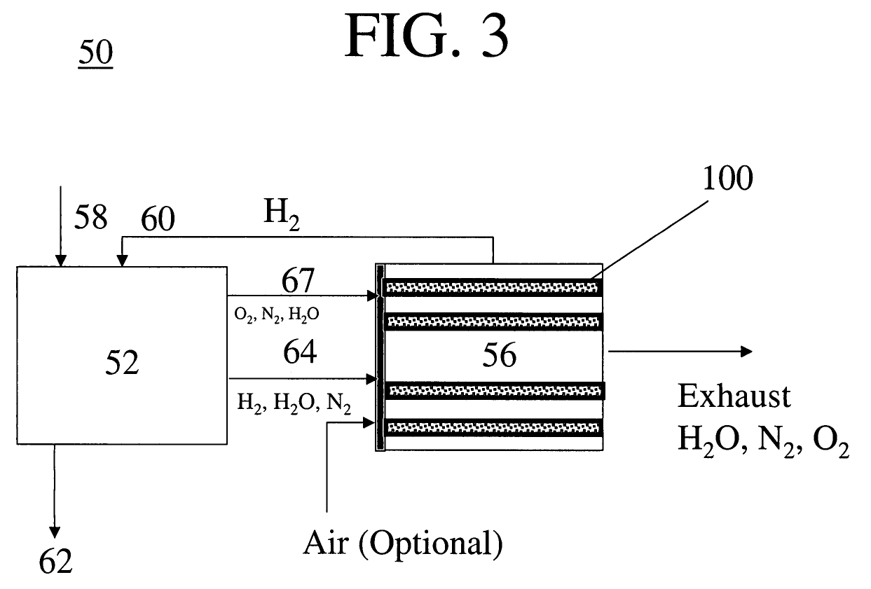

In accordance with another embodiment of the instant invention, FIG. 3 depicts fuel cell system 50 with at least one and typically a plurality of catalytic combustors 100 embedded within the hydrogen storage system 56. This embodiment incorporates the catalytic combustion directly into the hydrogen storage system 56, thereby improving the heat exchange between the offgas 66 of the catalytic combustion and the hydrogen storage system and limiting the overall footprint of the system.

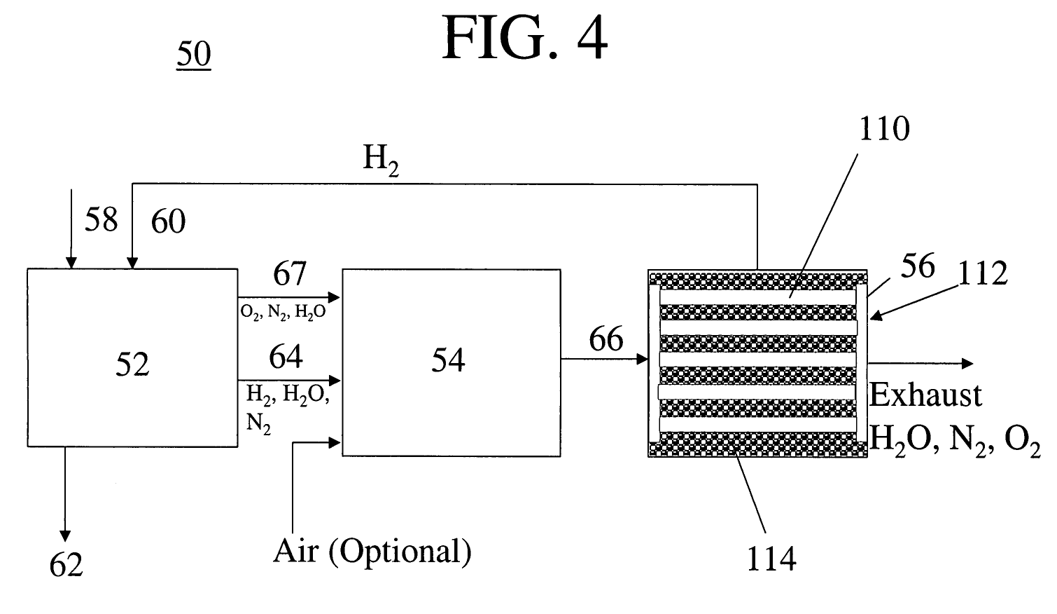

FIG. 4 shows another specific design of such a system. The offgas 66 exiting the catalytic combustor 54 is directed to a tube side 110 of a heat exchanger 112 embedded within hydrogen storage system 56 to heat up an adjacent H₂ storage material 114.

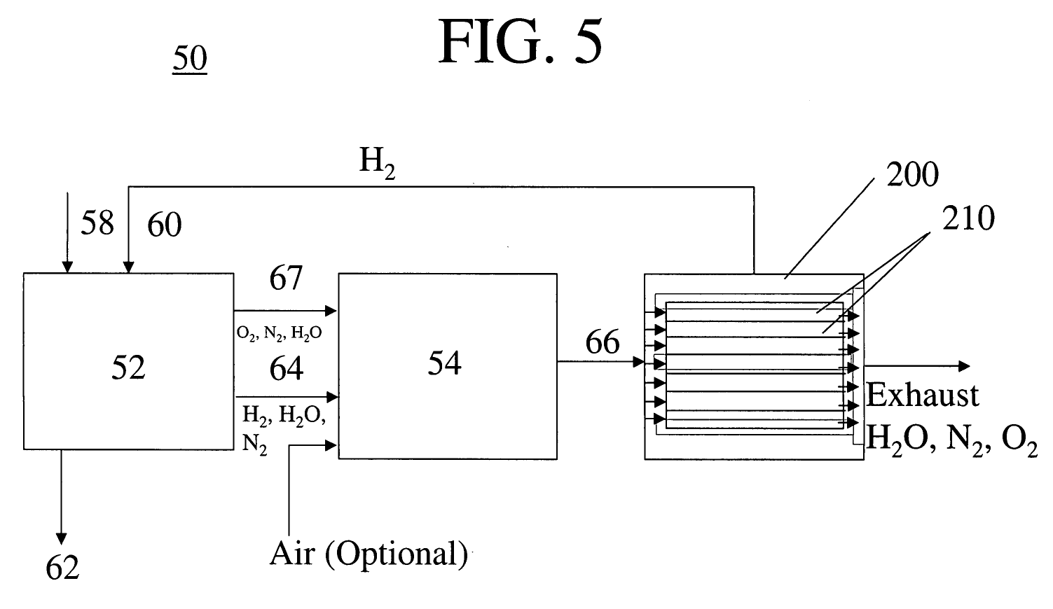

FIG. 5 depicts another embodiment of the instant invention. In this embodiment, offgas 66 exiting the catalytic combustor 54 is directed to hydrogen storage system 200. Hydrogen storage system 200 comprises a plurality of segmented storage sections 210. Hydrogen storage system 200 is configured to direct offgas 66 to one or more storage section 210, while preventing flow to the other storage sections 210. The directed offgas 66 heats up the storage material disposed within the respective storage section(s) 210, while adjacent storage sections 210 remain unaffected. An automobile may carry up to about 50 kg of a storage material to provide about 5 kg of H₂ (assuming that the storage material has a 10% wt H₂). Instead of using offgas 66 to heat the entirety of the storage material, system 200 provides a plurality of storage sections 210. By directing offgas 66 to a respective storage section 210, the storage system 200 provides adequate onboard storage capacity and simplified and efficient heating of storage material.

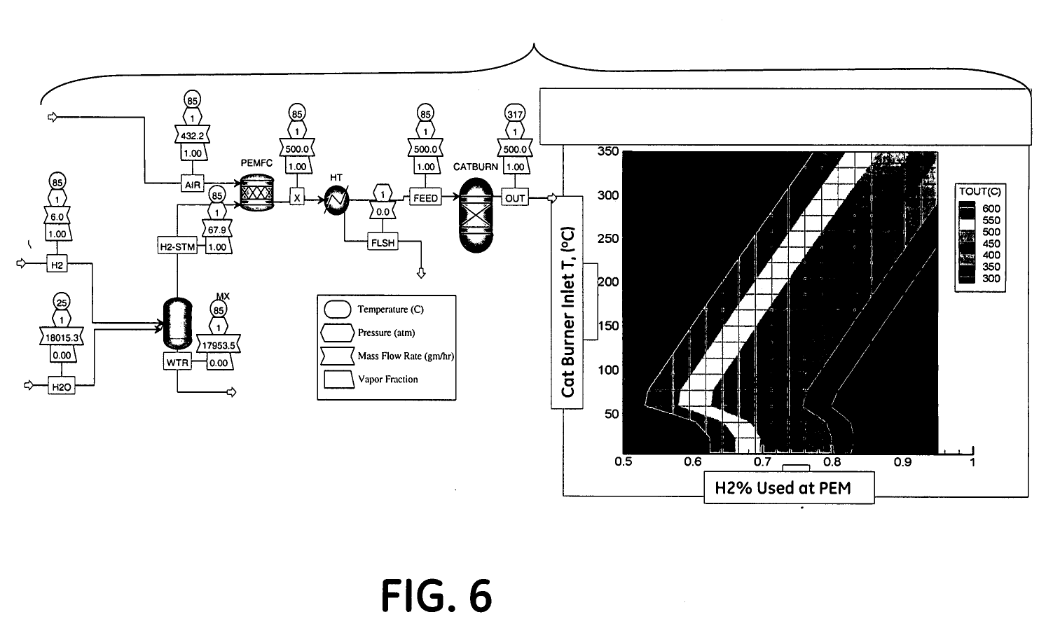

As shown in the FIG. 6, a PEM fuel cell system model has been developed using ASPEN, a commercially available simulation tool. Assume the PEM fuel cell operates at about 85 C, and that both the anode exhaust and the cathode exhaust are at about 85° C. The outlet temperature depends on the H₂ utilization rate in the PEM fuel cell, which also determines the hydrogen percentage that eventually feeds in into the catalytic combustor. As shown by the graphical portion of FIG. 6, the simulation demonstrates a significant temperature rise from inlet temperature to outlet temperature of the catalytic burner, varying by hydrogen percentage fed into the catalytic burner.

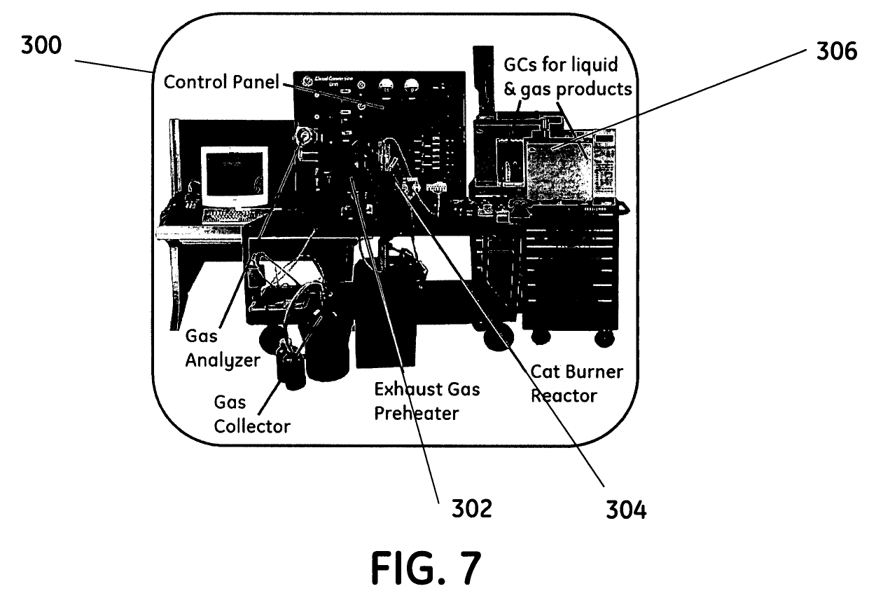

FIG. 7 shows an experimental unit 300 used to conduct catalytic burner testing. In this experimental setup, a variety of gases including N₂, H₂, O₂ and steam are mixed to simulate the mixture of a PEM anode and cathode exhaust. The mixture is then preheated within an exhaust gas preheater 302 to about 80° C. Next, a catalytic combustion catalyst is loaded into the catalytic combustor 304. A heater is provided to control and vary the catalyst temperature within catalytic combustor 304. Once the temperature of the catalyst is stabilized, the mixture is directed from the exhaust gas preheater 302 towards the catalytic combustor 304 and is analyzed using a measurement device 306 to monitor the outlet temperature from the catalytic combustor 304.

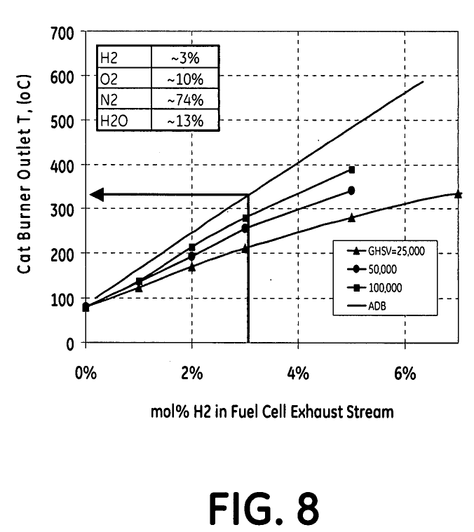

FIG. 8 graphically depicts the catalytic combustor 304 outlet temperature measured at different GHSVs and at different H₂ inlet concentrations. Notice from this chart that the catalytic oxidation reaction of the H₂ can be ignited at about 80° C. even at very low H₂ concentrations, for example about 1% and with low O₂ concentrations, for example less than 10%. In a small-scale test unit such as the one utilized here, the heat loss from the reactor walls is significant. One way to reduce the influence of the heat-loss is to increase the space velocity of the mixture into the inlet of the catalytic combustor 304. As one can see from the chart, the greater the space velocity, the closer the measured outlet temperature is to the adiabatic temperature. The data also indicates that the catalytic oxidation reaction is a fast reaction and is not limited by the GHSV, and in fact, the higher the GHSV, the higher the catalytic combustor outlet temperature. Using a GHSV of about 100,000, for a 50 KW PEM fuel cell (typical for a passenger car), this system, in a rudimentary implementation would only require about 1.2 liters of catalytic combustion catalyst, and this would improve as design improvements are implemented.

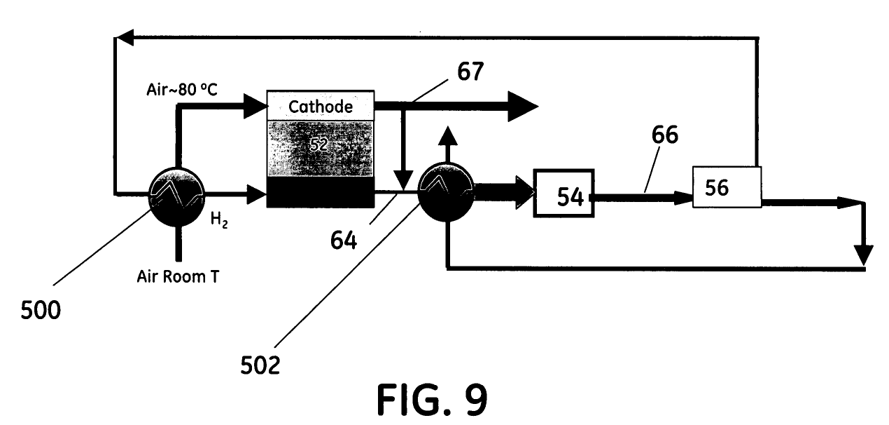

One embodiment of the instant invention is shown in FIG. 9. The hydrogen desorbed from the hydrogen storage tank can still be at a high temperature in the range of 150° C. to 400° C. for example. The high temperature hydrogen cannot be directly fed into the fuel cell. A regenerative heat changer 500 can be used to extract the heat to pre-heat the oxidant such as air into the fuel cell and reduce the hydrogen temperature to a value such as 80° C. that is compatible with the fuel cell working temperature. The exhaust after passing through the hydrogen storage tank can also still be at a high temperature in the range of 150° C. to 400° C. for example. The heat in the high temperature exhaust may be recovered through a second heat exchanger 502 to pre-heat the fuel cell exhaust 64 to recover the heat and can further increase the temperature of the catalytic combustor offgas 66.

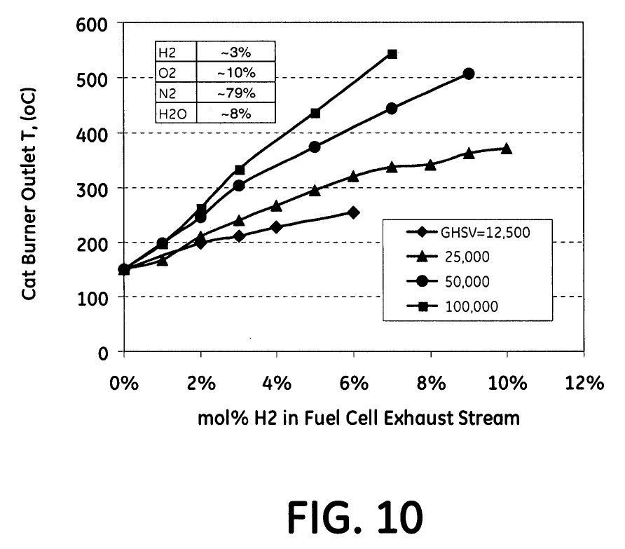

FIG. 10 graphically illustrated test results obtained using a catalytic combustor 304 inlet temperature of about 150° C. The measured outlet temperature from the catalytic combustor 304 is about 350° C. at 3% H₂ and GHSV of 100K; and under true adiabatic conditions, this system can expect to have a measured outlet temperature from the catalytic combustor of greater than about 400° C. at relatively low H₂ concentrations, for example about 3% H₂ by volume.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell system comprising:
a hydrogen storage system for storing and releasing hydrogen;
a fuel cell in fluid communication with said hydrogen storage system for receiving released hydrogen from said hydrogen storage system and for electrochemically reacting said hydrogen with an oxidant to produce electricity and an anode exhaust; and
a catalytic combustor in fluid communication with said fuel cell for receiving at least a portion of said anode exhaust and for catalytically reacting said anode exhaust to produce an offgas having an elevated temperature that is greater than the temperature of said anode exhaust;
wherein heat from said offgas is used to release said hydrogen from said hydrogen storage system.

2. A fuel cell system in accordance with claim 1, wherein said fuel cell is a PEM fuel cell.

3. A fuel cell system in accordance with claim 1, wherein said fuel cell is selected from the group consisting of a PEM fuel cell, a phosphoric acid fuel cell, and an alkali fuel cell.

4. A fuel cell system in accordance with claim 1, wherein said hydrogen storage system comprises at least one of a hydride material, glass spheres, glass tubes or combinations thereof.

5. A fuel cell system in accordance with claim 4, wherein said hydride material is a reversible metal hydride material.

6. A fuel cell system in accordance with claim 5, wherein said reversible metal hydride material has a reversible storage capacity of greater than about 5.0 weight percent.

7. A fuel cell system in accordance with claim 5, wherein said reversible metal hydride material comprises MgH₂.

8. A fuel cell system in accordance with claim 5, wherein said reversible metal hydride material comprises a mixture of LiBH₄ and MgH₂ in a two to one ratio, respectively.

9. A fuel cell system in accordance with claim 1, wherein said anode exhaust comprises less than about 15% by volume of hydrogen.

10. A fuel cell system in accordance with claim 1, wherein the temperature of said anode exhaust is in the range between about 60° C. to about 150° C.

11. A fuel cell system in accordance with claim 1, wherein the temperature of said anode exhaust is less than 150° C.

12. A fuel cell system in accordance with claim 1, wherein the temperature of said offgas is greater than about 150° C.

13. A fuel cell system in accordance with claim 1, wherein the temperature of said offgas is in the range between about 150° C. to about 900° C.

14. A fuel cell system in accordance with claim 1, wherein said catalytic combustor comprises a combustion catalyst.

15. A fuel cell system in accordance with claim 14, wherein said combustion catalyst is at least one of Pt/Al₂O₃, Pt—Pd/Al₂O₃, Pt—Rh/Al₂O₃, Pt—Re/Al₂O₃, Pt—Ru/Al₂O₃, or Pt—Ir/Al₂O₃.

16. A hydrogen storage system comprising:
a hydrogen storage material for storing and releasing hydrogen;
an exhaust source for producing an exhaust having a hydrogen content of between about 0 to about 15% by volume; and
a catalytic combustor in fluid communication with said exhaust source for receiving said exhaust and for catalytically reacting said exhaust to produce an offgas having an elevated temperature that is greater than a temperature of said exhaust;
wherein heat from said offgas is used to release said hydrogen from said hydrogen storage material.

17. A fuel cell system comprising:
a metal hydride hydrogen storage system for storing and releasing hydrogen, wherein said storage system has a reversible storage capacity of greater than about 7.5 weight percent;
a PEM fuel cell in fluid communication with said metal hydride storage system for receiving released hydrogen from said hydrogen storage system and for electrochemically reacting said hydrogen with an oxidant to produce electricity and an anode exhaust having a temperature of less than about 150 degrees Celsius; and
a catalytic combustor in fluid communication with said PEM fuel cell for receiving at least a portion of said anode exhaust and for catalytically combusting said anode exhaust to produce an offgas having a temperature greater than about 150 degrees Celsius;
wherein heat from said offgas is used to release said hydrogen from said hydrogen storage system.

18. A fuel cell system comprising:
a hydrogen storage system comprising a hydrogen storage material for storing and releasing hydrogen and at least one catalytic combustor in heat exchange relationship with said hydrogen storage material; and
a fuel cell in fluid communication with said hydrogen storage system for receiving released hydrogen from said hydrogen storage material and for electrochemically reacting said hydrogen with an oxidant to produce electricity and an anode exhaust;
wherein said anode exhaust is directed to said at least one catalytic combustor for catalytically reacting said anode exhaust to produce an offgas having an elevated temperature that is greater than the temperature of said anode exhaust;
wherein heat from said offgas is used to release said hydrogen from said hydrogen storage material.

19. A method of releasing hydrogen comprising the steps of:
electrochemically reacting hydrogen with an oxidant to produce electricity and an exhaust;
catalytically reacting said exhaust to create an offgas having an elevated temperature;
heating a hydrogen storage material using said offgas having an elevated temperature to release the hydrogen from said hydrogen storage material.

20. A method of releasing hydrogen in accordance with claim 19, further comprising the step of directing the hydrogen released from said hydrogen storage material for electrochemically reacting the hydrogen with an oxidant.

21. An automobile comprising:
a hydrogen storage system for storing and releasing hydrogen;
a fuel cell in fluid communication with said hydrogen storage system for receiving released hydrogen from said hydrogen storage system and for electrochemically reacting said hydrogen with an oxidant to produce electricity and an anode exhaust; and
a catalytic combustor in fluid communication with said fuel cell for receiving at least a portion of said anode exhaust and for catalytically reacting said anode exhaust to produce an offgas having an elevated temperature that is greater than the temperature of said anode exhaust;
wherein heat from said offgas is used to release said hydrogen from said hydrogen storage system.

22. An automobile comprising:
a fuel cell for electrochemically reacting hydrogen with an oxidant to produce electricity and an anode exhaust; and
a catalytic combustor in fluid communication with said fuel cell for receiving said anode exhaust and for catalytically reacting said anode exhaust to produce an offgas having an elevated temperature that is greater than the temperature of said anode exhaust.
